(19) United States
(12) Patent Application Publication
(10) Pub. No.: US 2010/0030888 A1
(43) Pub. Date: Feb. 4, 2010

(54) APPARATUS, AND ASSOCIATED METHOD, FOR MONITORING SYSTEM EVENTS

(75) Inventors: NAZIFA NAWABZADA, SAN RAMON, CA (US); MING-JYE PAN-CHEN, SAN JOSE, CA (US); NANCY WU, LIVERMORE, CA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: ELECTRONIC DATA SYSTEMS CORPORATION, PLANO, TX (US)

(21) Appl. No.: 12/181,457

(22) Filed: Jul. 29, 2008

(51) Int. Cl. G06F 15/173; G06F 17/30; G06F 3/048

(52) U.S. Cl. 709/224; 707/102; 715/764; 707/E17.005

(57) ABSTRACT

An apparatus, and an associated method, for facilitating monitoring of a system, such as a system formed of an IT infrastructure. A detector detects the occurrence of system events, such as system faults or other anomalies. The detected events are matched with a set of rules, such by correlating attributes of the detected system events, to determine which events are related. Related events are grouped together into a group. An identification of the group is generated and displayed upon a display monitor. The individual events that comprise the group are hidden from view, i.e., collapsed behind the group identification.

The present invention relates generally to a manner by which to monitor the occurrence of system events, such as IT (Information Technology) faults, that occur during, or pursuant to, operation of a system. More particularly, the present invention relates to an apparatus, and an associated method, by which automatically to correlate system events that are related to a common event occurrence and to collapse the related events into a single display indication on a display monitor.

Multiple display indications that are related to the common event occurrence, which would otherwise be displayed, are instead represented by the single display indication. Display clutter is reduced, and resolution of the underlying cause of the common event occurrence is facilitated.

### BACKGROUND OF THE INVENTION

Many types of business, and other, enterprises provide for the monitoring of enterprise operations. The monitoring is oftentimes continuous, particularly in a production environment in which a production anomaly might have significant production-related effects. If the anomaly is serious, production might, or other operations, might be interrupted. Resultant costs in lost revenue and customer dissatisfaction might well be a serious consequence.

For instance, an enterprise oftentimes monitors the ongoing operations of its IT (Information Technology) operations. And, analogously, some enterprises are dedicated to the operation of IT devices. Monitoring of the performance of the IT devices by such enterprises is typically one of the primary tasks that are performed. Monitoring of the IT devices is sometimes provided by personnel dedicated to such monitoring. An operations center, e.g., is maintained, in connectivity with the IT devices of the computer system. Occurrence of a system event, i.e., a system anomaly or fault, is detected at the operations center. And, in response, determination is made by personnel of the operations center in what manner to respond to the event.

A display monitor is typically used at the operations center to display an indication of the occurrence of the system event. Additional, or alternate, types of alerts are also sometimes provided. For instance, if the system event is of particular significance, an aural alert might well be provided together with the visual-display indication.

Sometimes, the personnel of the operations center, upon detection of the system event, create an incident ticket and engage appropriate resources in order to rectify the event.

When the system that is monitored is large, such as an IT infrastructure that is distributed throughout one or more facilities, a potentially large number of system events are possible. Their occurrence at the same time, or within a short period of time, might well quickly become problematical as the indications of their occurrence, displayed upon the monitor display might well result in a cluttered appearance and cause some level of confusion on the part of the personnel of the operations center when deciding in what manner, and in what order, to respond to the detected, system events

Sometimes, multiple system event occurrences might be related to the same underlying problem or anomaly. For instance, a single fault might result in the generation of many system events, indications of which each of the system events is displayed at the display monitor. The display of the multiple indications of the same underlying anomaly, not only is confusing, but also is redundant. Additionally, the indications of the system events generally do not provide any correlation information. The personnel at the operations center must generally make their own determination of whether the displayed system events are related. In other words, the displayed events, even caused by the same fault, are handled individually by the operations-center personnel. Many times, multiple incident tickets are created for the same, underlying system anomaly. And, resources are engaged to address the multiple incident tickets. When deployed in this manner, the resources expended are many times likely to be well more than the resources needed to address the underlying anomaly. Additionally, the resources that are deployed are not necessarily aware of the relationship between the system events and, as a result, have more difficulty in resolving the incident tickets. That is to say, because the resources are less likely to be aware of the overall problem, but rather only are aware of the particular system event identified by the incident ticket, the resources have greater difficulty in correcting the underlying anomaly.

While certain operations centers provide personnel thereat with the capability to collapse redundant indications to reduce the clutter that appears on the screen monitor, the existing mechanisms require manual selection. That is to say, personnel at the operations center must select which indications to collapse and then enter the selections.

Existing monitoring of system events, therefore, exhibit various deficiencies. What is needed, therefore, is an approved manner by which to monitor system events.

It is in light of background information related to system monitoring that the significant improvements of the present invention have evolved.

### SUMMARY OF THE INVENTION

The present invention, accordingly, advantageously provides an apparatus, and an associated method, by which to monitor the occurrence of system events, such as IT faults, that occur during, or pursuant to, operation of a system.

Through operation of an embodiment of the present invention, a manner is provided by which automatically to correlate system events that are related to a common event occurrence. Indications of related system events are collapsed into a single display indication, displayable on a display monitor.

In one aspect of the present invention, multiple display indications that are related to common event occurrences are represented by a group display indication, e.g., a single display indication. Display clutter that would otherwise occur as a result of display of indications of all of the related event occurrences is reduced or eliminated. By providing a less-cluttered display, personnel viewing the display are more easily able to identify an underlying anomaly and more readily able to resolve the anomaly giving rise to the occurrence of the system event.

In another aspect of the present invention, a system event detector is positioned in connectivity with system devices, such as IT infrastructure devices of an IT system. When so-connected, the detector detects occurrence of system events, such as faults or other anomalies, which occur during operation of the system. Indication of occurrence of a system event is, e.g., automatically sent by a system device or is otherwise automatically detected by the detector.

In another aspect of the present invention, the detected, system events have attributes associated therewith, indicating, for instance, indicia associated with the location, type, time of, etc., of the system event. Analysis is made of the detected events and their respective attributes. The analysis is made in order to group together detected system events that have common attributes.

In another aspect of the present invention, a system event attribute grouper is provided by which to group together related, system events whose occurrence has been detected. The system event attribute grouper groups together detected system events into a group if the attributes of the system events indicate the system event to be related, such as resulting from occurrence of the same underlying anomaly or condition.

In another aspect of the present invention, a set of rules is used in the determination of whether the detected, system events exhibit common attributes. The set of rules is, e.g., an externally-manageable set of rules that is updatable, when desired. The rules of the set are accessed and used to ascertain which of the detected system events, if any, can be grouped together in a single group.

In another aspect of the present invention, correlation is performed upon the detected, system events and their associated attributes. The correlation is performed automatically and, e.g., if the resultant correlation values are higher than a threshold value, the associated system events are considered to be related, and are grouped together into a common group. The correlation values are, e.g., compared by a comparator with the threshold value, and results of the comparison are used to determine whether the associated system events are correlated with one another.

In another aspect of the present invention, a data base is provided at which to store the detected events and the groupings thereof. The data base is subsequently accessible and updatable.

In another aspect of the present invention, an event display generator is provided that generates a display indication for display upon a display monitor, or other display device. The display generator operates automatically, pursuant to an auto-collapse policy, by which to collapse system events of a single group into a single indication for display. A hierarchical UI (user interface) presenter is provided that presents the grouped-together, system events in a hierarchical manner. An indication is provided that identifies the entire group. Indications of the system events are collapsed and cascaded beneath the group indication. The indications are displayable responsive to subsequent selection of display of the cascaded indications, cascaded beneath the group indication. Because a group indication, e.g., a single indication, is substituted for all of the indications associated with individual system events of the group, a less cluttered display is provided.

Operations are performed automatically to detect the occurrence of system events, to group together related system events, and to display an indication of the group into which the individual, system events are grouped. Intervention by operating personnel to form the display is not needed; the operating personnel merely provide addition instructions in the event that viewing of indications of individual ones of the system events within the group is desired.

When implemented at an operations center that monitors operation of an enterprise, IT infrastructure, personnel of the operations center are provided with a less-cluttered screen display in which related, system events are grouped together and identified by a common identification.

In these and other aspects, therefore, an apparatus, and an associated method is provided that for facilitating system event monitoring. A system event attribute grouper is configured automatically to group together detected system events that have common attributes. An event display generator is configured to generate the display of an indication that is representative of a group of the detected system events, once grouped together.

A more complete appreciation of the scope of the present invention and the manner in which it achieves the above-noted and other improvements can be obtained by reference to the following detailed description of presently-preferred embodiments taken in connection with the accompanying drawings that are briefly summarized below, and by reference to the appended claims.

### BRIEF DESCRIPTION OF THE DRAWINGS

FIG. 1 illustrates a functional block diagram of an arrangement that includes a monitoring system that operates pursuant to an embodiment of the present invention.

FIG. 2 illustrates a process diagram representative of the process of operation of an embodiment of the present invention.

FIG. 3 illustrates a process flow representation of an embodiment of the present invention.

FIG. 4 illustrates a method flow diagram representative of the method of operation of an embodiment of the present invention.

### DETAILED DESCRIPTION

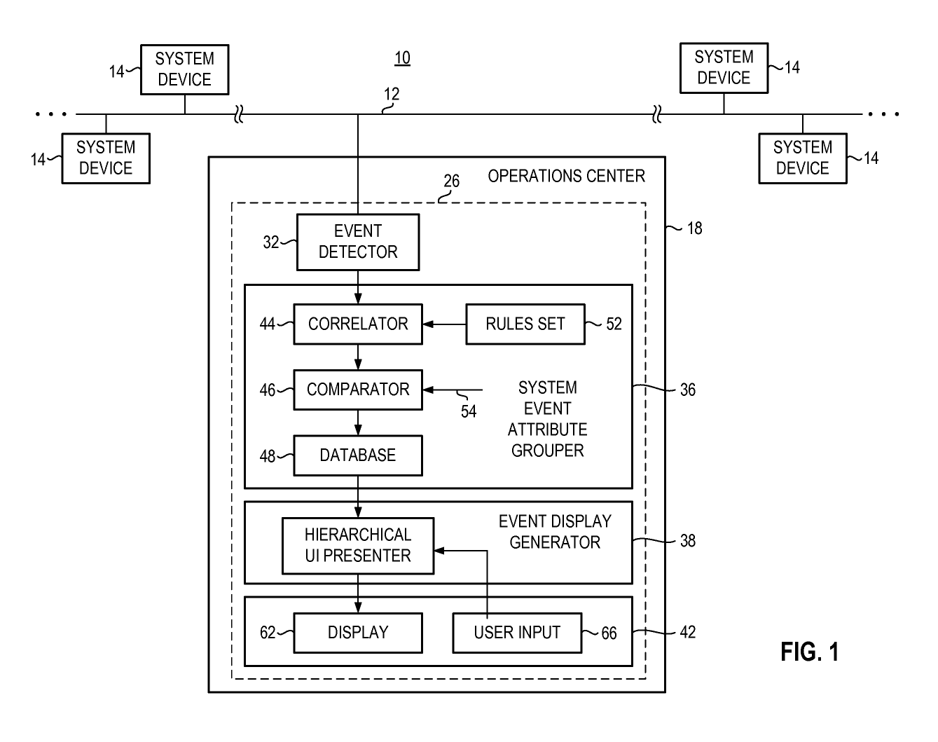

Referring first, to FIG. 1, an arrangement, shown generally at 10, is representative of a system having a plurality of system devices 14. In the exemplary implementation, the arrangement 10 comprises an IT (Information Technology) infrastructure, and the system devices 14 comprise IT devices, such as computer stations and computer-related devices. More generally, the arrangement is representative of any of various types of enterprise, production, and other systems that have a plurality of system devices whose operation is to be monitored. Accordingly, while the following description shall describe exemplary operation shall be described with respect to an implementation in which the arrangement comprises an enterprise, IT infrastructure, the operation in other types of systems is analogous, and can be analogously described.

An operations center 18 is positioned in connectivity with the system devices 14. Connectivity is provided in any of various manners, including, for instance, interconnections by way of a network 22 with the system devices, radio-link connectivity, etc. The system devices 14 are, e.g., directly connected to the network 22 connected by way of wide area network connections permitting operations-center connectivity with devices 14 that are both locally-connected as well as distributed at remote locations.

The operations center provides for the monitoring of the system devices and typically one or more operating personnel oversee the monitoring activities. As mentioned previously, particularly when the system that is to be monitored has a large number of system devices, and the devices have interdependencies, the potential number of system events that might occur within a period is potentially large. When indications of multiple, system-event occurrences are generated within a short period, each indication is typically separately handled with a separate incident ticket, each requiring operations-center personnel to create and to respond to. As also noted previously, multiple system-event occurrences might pertain to a single underlying anomaly. The multiple, system-event indications might well be not only redundant, but also counterproductive as the operating personnel respond to the multiple indications, all related to the same underlying anomaly.

Accordingly, pursuant to an embodiment of the present invention, an apparatus 26 is provided to facilitate monitoring operations at the operations center. The elements of the apparatus are functionally represented, implementable in any desired manner, including by algorithms executable by processing circuitry. And, while all of the elements of the apparatus 26 are shown in the exemplary implementation to be embodied at the operations center 18; in other implementations, the apparatus has elements distributed at different physical locations.

The apparatus 26 is here shown to include an event detector 32, a system event attribute grouper 36, an event display generator 38, and a user interface (UI) 42.

The event detector 32 is connected, here to the network connection 22, to detect occurrence of system events that occur during operation of the system. When occurrence of a system event is detected, the detection of the occurrence, together with attributes associated with the system event, are provided to the system event attribute grouper. The information is, e.g., cached at a memory cache (not shown in FIG. 1). The system event attribute grouper operates to group together system events that have common attributes. That is to say, the grouper determines which of the vents have matching attributes. In the exemplary implementation, the system event attribute grouper includes an auto-correlator 44, a comparator 46, a data base 48, and a set of rules 52, stored, e.g., at a memory element. The correlator 44 correlates the detected, system events to determine correlations, at least in terms of a correlation value, between the detected system events. The correlation is made with respect to rules of the set of rules 52 that define, for instance, which attributes of the system events are to be considered, and rules determinative of in what manners that the attributes shall be treated. The rules of the set of rules comprise auto-collapse rules. If the detected events match the rules, the events are grouped by the common attributes.

The comparator 46 is here representative of a comparison of the calculated correlation values with a threshold value here represented to be provided by way of the line 54 to permit a determination as to whether system events are correlated to an extent to permit a determination that the system events are the consequence of a common, system anomaly. The data base 48 maintains results of the determinations of the correlations, i.e., commonalities and groupings of the detected, system events. An auto-collapse policy associated with the auto-collapse rules is applied. The policy defines the manner by which the events shall be displayed.

The event display generator includes a hierarchical UI presenter 58 that accesses the contents stored at the data base 48. The presenter operates to generate an indication of a group of system events that have been determined to be related, such as to have been generated responsive to the same underlying anomaly. The indication generated by the presenter 58 comprises, when displayed, an icon representative of group. The indication is provided to the user interface 42 for display at a display 62 thereof. Instead of multiple indications for each of the system events of the group, only the indication, e.g., a single icon, that is representative of all of the system events of the group is displayed. Indications of the system events of the group are collapsed in a hierarchical manner, and not displayed at the display but upon separate request, here input by way of an input element 66. Through input of the additional selection, the display caused to be displayed on the display device 62 is of one or more of the system events of the group. Additional information, such as the attributes associated with the events are also displayable.

Because multiple indications, determined to be highly correlated, are replaced with a group indication, clutter on the display device 62 is reduced, facilitating remedial operations by the personnel of the operating center to remedy the underlying anomaly. Rather than creating incident tickets for each system event of the group, only a single incident ticket, related to the group, is created and addressed.

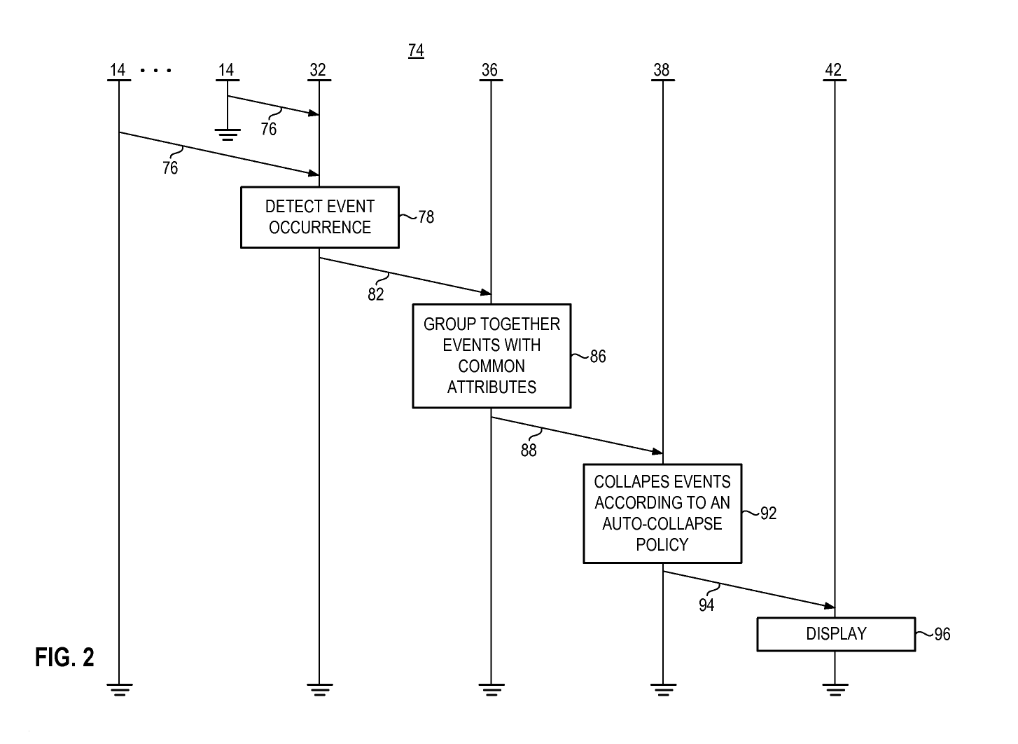

FIG. 2 illustrates a process diagram, shown generally at 74, representative of exemplary operation of an embodiment of the present invention by which to facilitate monitoring of system events occurring in an IT infrastructure, or other system.

Here, multiple system event occurrences are reported, indicated by the segment 76, by multiple system devices 14. The detector 32 of the operations center detects, indicated by the block 78, occurrence of the system events. And, indications of the detected system events are provided, indicated by the segment 82, to the system event attribute grouper 36. The system events that exhibit common attributes are grouped together, indicated by the block 86.

Then, as indicated by the segment 88, and the block 92, the system events are collapsed pursuant to an auto-collapse policy such that a single indication, associated with the group of system events is substituted for the system events of the group. And, as indicated by the segments 94 and 96, the indication is provided to the user interface 42 and displayed at the display device thereof.

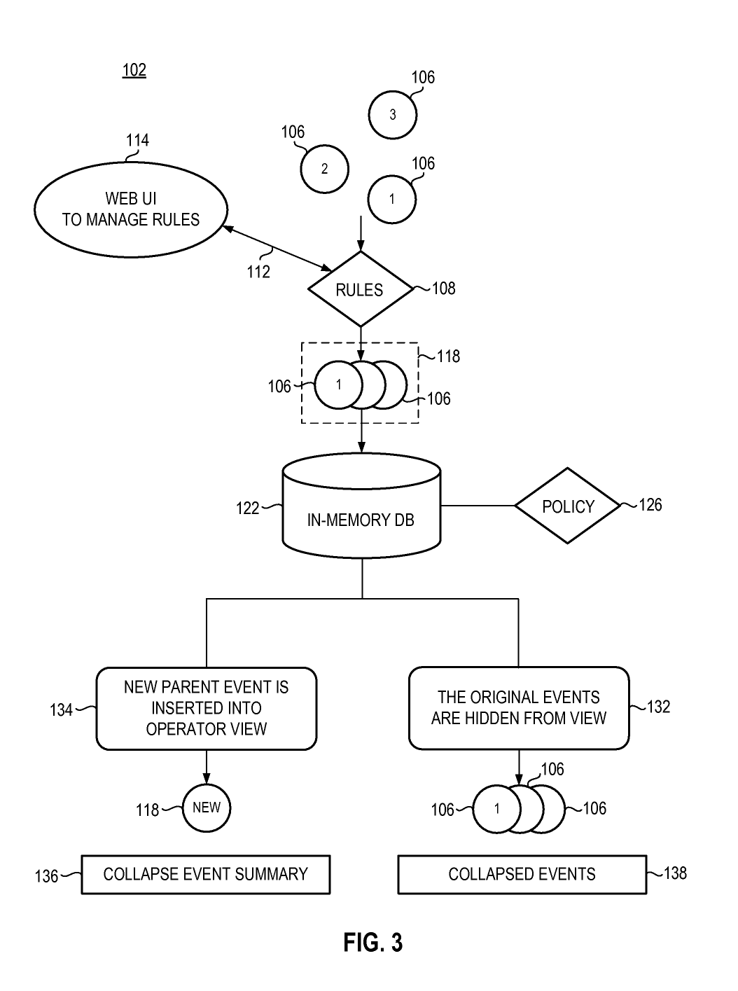

FIG. 3 illustrates a process flow representation of operation of an embodiment of the present invention to collapse multiple system events to simplify their display and to facilitate monitoring of a system.

Here, for purposes of example, three events 106 are shown. The events 106 originate from the same underlying anomaly, i.e., fault. Occurrence of the events is detected, and auto-collapse rules are applied, as indicated by the decision block 108. The rules are, in the exemplary implementation, externally managed, here indicated by way of the line 112 extending to the block 14 indicative of use of an internet (WEB) user interface by way of which the rules of the set of rules are managed.

The rules are applied at the decision block 108 to determine whether the events 106 and their associated attributes, match the rules. Here, for purposes of example, the events 106 are related and match the defined rules. The events 106 are grouped into a group 118. And, the events, once grouped into the group 118, are written to an in-memory, event data base 122.

An auto-collapse policy is applied, indicated by the decision block 126, is applied to the events stored at the data base 122. The application of the auto-collapse policy determines in what manner that the events of the group shall be viewed. In the exemplary implementation, the events 106 that are related and from the single group 118 are hidden from view in a display that is subsequently displayed upon a display monitor. The related events are hidden from view, indicated by the block 132, and a single-group event is displayed, indicated by the block 134. Personnel at the operations center at which the display is presented are able to view, indicated by the block 136, or to drill down beneath the group event identification 138 to view the individual events 106 that form the group.

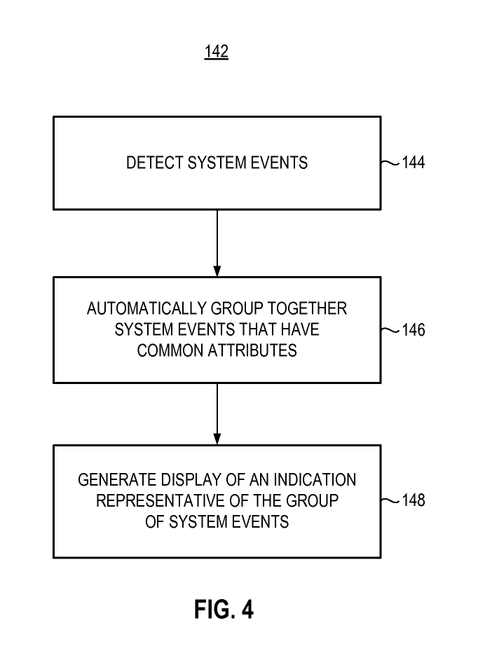

FIG. 4 illustrates a method flow diagram representative of the method of operation of an embodiment of the present invention. The method 142 facilitates system event monitoring.

First, and as indicated by the block 144, system events are detected. Then, and as indicated by the block 146, detected system events that have common attributes are automatically grouped together. And, as indicated by the block 148, a display of an indication representative of a group of the detected system events, once grouped together, is generated.

Because the operations are carried out automatically without need of operator intervention in order to group together related system events and collapse the related events into a group identification thereof, an improved display is provided without requiring additional action by operating personnel. Improved response to system-event occurrences is provided.

Presently-preferred embodiments of the invention and many of its improvements and advantages have been described with a degree of particularity. The description is of preferred examples of implementing the invention and the description of the preferred examples is not necessarily intended to limit the scope of the invention. The scope of the invention is defined by the following claims.

What is claimed is:

1. An apparatus for facilitating system event monitoring, said apparatus comprising:
a system event attribute grouper configured automatically to group together detected system events having common attributes; and
an event display generator configured to generate display of an indication representative of a group of the detected system events, once grouped together by said system event attribute grouper.

2. The apparatus of claim 1 further comprising an event detector configured to detect occurrence of the system events.

3. The apparatus of claim 1 wherein the system event attribute grouper is configured to group together the detected system events according to a set of rules.

4. The apparatus of claim 3 wherein the set of rules comprises externally-manageable rules.

5. The apparatus of claim 1 wherein the event display generator is further configured to select the indication responsive to an auto-collapse policy.

6. The apparatus of claim 1 wherein the indication comprises a single indication representative of the group.

7. The apparatus of claim 1 wherein the system event attribute grouper is configured to correlate attributes of the detected system events.

8. The apparatus of claim 7 wherein the system event attribute grouper is configured to group together detected system events that have correlated attributes.

9. The apparatus of claim 8 wherein the system event attribute grouper groups together detected system events that have greater than a threshold level of correlated attributes.

10. The apparatus of claim 1 further comprising a database configured to store representations of the detected system events grouped together by said system event attribute grouper.

11. The apparatus of claim 10 wherein said event display generator is configured to access the representations of the detected system events and to generate the indication representative of group of the detected system events.

12. The apparatus of claim 1 wherein said event display generator is further configured to provide for display, in collapsed form, beneath the indication representative of the group, identification of the detected system events of the group.

13. A method for facilitating system event monitoring, said method comprising: automatically grouping together detected system events having common attributes; and generating display of an indication representative of a group of the detected system events, once grouped together during said automatically grouping together.

14. The method of claim 13 further comprising detecting the system events.

15. The method of claim 13 wherein said automatically grouping together comprises correlating attributes of the detected system events.

16. The method of claim 15 wherein said automatically grouping further comprises grouping together the detected system events that have greater than a threshold level of correlated attributes.

17. The method of claim 13 further comprising generating display, if selected, of identification of the detected system events of a group of which the indication is representative.

18. The method of claim 17 further comprising detecting selection of the identification of the detected system events of the group of which the indication is representative.

19. The method of claim 13 wherein said automatically grouping is performed in conformity with a set of rules.

20. A method for facilitating monitoring of IT, information technology, system events, said method comprising:
automatically correlating detected IT system events using a set of pre-defined rules;
automatically collapsing IT system events determined during said automatically correlating to be correlated into a single entity; and
presenting for display the single entity and collapsed IT system events in a hierarchical manner.
